(19) United States
(12) Patent Application Publication
(10) Pub. No.: US 2012/0001788 A1
(43) Pub. Date: Jan. 5, 2012

(54) TRANSPONDER DECODER

(75) Inventors: Lee R. Carlson, Grand Rapids, MI (US); Blake R. Getson, Columbus, OH (US); James R. Troxel, Glendale, AZ (US)

(73) Assignee: L-3 Communications Avionics Systems, Inc., Grand Rapids, MI (US)

(21) Appl. No.: 13/171,022

(22) Filed: Jun. 28, 2011

Related U.S. Application Data
(60) Provisional application No. 61/360,984, filed on Jul. 2, 2010.

(51) Int. Cl. G01S 13/91

(52) U.S. Cl. 342/30

(57) ABSTRACT

An Automatic Dependent Surveillance-Broadcast (ADS-B) system for an aircraft and method of automatically harmonizing a transponder squawk code and an ADS-B system such that a squawk code broadcast by the ADS-B system matches the transponder squawk code, includes transmitting the transponder squawk code from a transponder positioned onboard an aircraft and receiving the transmitted transponder squawk code with a device positioned onboard the aircraft. The ADS-B system is updated with the received transmitter squawk code. The squawk code is transmitted using the ADS-B system.

### CROSS-REFERENCE TO RELATED APPLICATION

This application claims priority from U.S. provisional patent application Ser. No. 61/360,984, filed on Jul. 2, 2010, the disclosure of which is hereby incorporated herein by reference in its entirety.

### BACKGROUND OF THE INVENTION

The present invention relates to aircraft communication systems, and more particularly to aircraft communication systems that provide identifying information about an aircraft, such as, but not limited to, transponders and Automatic Dependent Surveillance-Broadcast (ADS-B) systems.

The United States Federal Aviation Administration (FAA) has current plans to require that all aircraft include an Automatic Dependent Surveillance-Broadcast (ADS-B) system onboard by 2020. ADS-B systems are systems in which an aircraft repetitively broadcasts information about itself to both the air traffic control (ATC) system and any other aircraft within the vicinity of the broadcasting aircraft. The broadcast information includes, among other items, the aircraft's three-dimensional position and velocity, as well as an air traffic control assigned transponder code, also known as a Squawk code. In some instances, an aircraft equipped with the ADS-B system may also have an air traffic control radar beacon system (ATCRBS), which is a mode A/C transponder, onboard the aircraft. As is known in the art, the mode A/C transponder responds to certain interrogations by broadcasting a Squawk code that is received by air traffic control. Confusion at air traffic control may result if the mode A/C transponder Squawk code does not match the Squawk code broadcast by the ADS-B system from the same aircraft. The terms Squawk code and mode A Squawk code are used interchangeably throughout this document, but are intended to refer to the same code.

### SUMMARY OF THE INVENTION

According to its various embodiments, the present invention provide methods and systems for automatically ensuring that the aircraft identifying information, such as the Squawk code, broadcast by a transponder, such as an ATCRBS transponder, matches the aircraft identifying information broadcast by the ADS-B system. In other words, the various embodiments provides methods and systems for ensuring that an aircraft will not inadvertently broadcast different or multiple identification information through its transponder and its ADS-B system.

A transponder decoder for an aircraft, according to an aspect of the invention, includes an input adapted to receive a mode A/C transponder transmission from a transponder positioned aboard the aircraft. A decoder is adapted to decode the mode A/C transponder transmission. An output outputs the decoded mode A/C transponder transmission.

An Automatic Dependent Surveillance-Broadcast (ADS-B) device may be coupled to the output. The ADS-B device is adapted to wirelessly broadcast at least the decoded mode A/C transponder transmission data. The input may include an antenna that is adapted to wirelessly detect the mode A/C transponder transmission. The ADS-B device may wirelessly broadcast the decoded mode A/C transponder transmission using a Universal Access Transceiver (UAT). The transponder transmission may include a mode A Squawk code and/or a mode C pressure altitude.

The ADS-B device may be adapted to determine that a transponder transmission is a mode A Squawk code. The ADS-B device may be adapted to determine that a transponder transmission is a mode A Squawk code by determining that the transponder transmission does not have the same value as pressure altitude information for the aircraft. The ADS-B device may be adapted to take an alternative action if it cannot determine that the transponder transmission is a mode A Squawk code. The alternative action may include providing an indication to the pilot. The alternative action may include sending an interrogation signal to activate the transponder to send a mode A Squawk code. The antenna may send the interrogation signal to the transponder.

The ADS-B device may be adapted to determine that the transponder is not transmitting. The ADS-B device is adapted to distinguish between said transponder not transmitting because (i) the transponder is not operational or (ii) the transponder is not being interrogated.

An Automatic Dependent Surveillance-Broadcast (ADS-B) system for an aircraft, according to an aspect of the invention, includes a transponder decoder having an input adapted to receive a mode A/C transponder transmission from a transponder positioned aboard the aircraft, a decoder adapted to decode the mode A/C transponder transmission and an output for outputting the decoded mode A/C transponder transmission. A message formatter is adapted to generate a message based on data received from the transponder decoder output. The message includes data identifying the Squawk code. A wireless transmitter is in communication with the message formatter. The wireless transmitter is adapted to wirelessly broadcast the message.

The transponder decoder may receive the Squawk code wirelessly from the transponder. The transponder decoder may also receive altitude information broadcast from the transponder and forward the altitude information to the message formatter for formatting into the message.

The message formatter may be adapted to determine that a transponder transmission is a mode A Squawk code. The message formatter may be adapted to determine that a transponder transmission is a mode A Squawk code by determining that the transponder transmission has a value that is not the same value as pressure altitude information for the aircraft.

The message formatter may be adapted to take an alternative action if it cannot determine that the transponder transmission is a mode A Squawk code. The alternative action may include providing an indication to the pilot. The alternative action may include sending an interrogation signal to activate the transponder to send a mode A Squawk code. The wireless transmitter may send the interrogation signal to the transponder. The message formatter may be adapted to determine that the transponder is not transmitting. The message formatter may be adapted to distinguish between the transponder not transmitting because (i) the transponder is not operational or (ii) the transponder is not being interrogated.

A transponder suppression bus input may be provided that is adapted to be coupled to a transponder suppression bus. The transponder suppression bus input may be adapted to receive a signal to help differentiate between data transmitted by the transponder onboard the aircraft and data transmitted by any transponders off-board the aircraft. The transponder decoder may also receive IDENT information broadcast from the transponder and forward the IDENT information to the message formatter for formatting into the message. The wireless transmitter may be a component of a Universal Access Transceiver (UAT).

A method of automatically harmonizing a transponder Squawk code and an ADS-B system such that a Squawk code broadcast by the ADS-B system matches the transponder Squawk code, according to an aspect of the invention, includes transmitting the transponder Squawk code from a transponder positioned onboard an aircraft and receiving the transmitted transponder Squawk code with a device positioned onboard the aircraft. The ADS-B system is updated with the received transmitter Squawk code. The Squawk code is broadcast using the ADS-B system.

The transmitted transponder Squawk code may be performed wirelessly using an antenna. A signal may be received from a transponder suppression bus and used to help differentiate between data transmitted by the transponder onboard the aircraft and data transmitted by any transponders off-board the aircraft. Altitude information broadcast from said transponder may be received and forwarded to the message formatter for formatting into the message.

It may be determined that a transponder transmission is a mode A Squawk code. This may be carried out by determining that the transponder transmission has a value that is not the same value as pressure altitude information for the aircraft. An alternative action may be taken if it cannot be determined that the transponder transmission is a mode A Squawk code. The alternative action may include providing an indication to the pilot. The alternative action may include sending an interrogation signal to activate the transponder to send a Mode A Squawk code. The interrogation signal may be sent to the transponder with the ADS-B system.

The method may include determining that the transponder is not transmitting. This may include distinguishing between the transponder not transmitting because (i) the transponder is not operational or (ii) the transponder is not being interrogated.

These and other objects, advantages and features of this invention will become apparent upon review of the following specification in conjunction with the drawings.

### BRIEF DESCRIPTION OF THE DRAWINGS

FIG. 1 is a diagram of a portion of an illustrative aircraft illustrating one potential location in the aircraft in which a transponder decoder according to one aspect of the invention may be positioned;

FIG. 2 is a block diagram of an ADS-B system according to an embodiment of the invention into which a transponder decoder is incorporated;

FIG. 3 is a block diagram of a transponder decoder according to another embodiment of the invention;

FIG. 4 is a flowchart of a method of automatically harmonizing a transponder Squawk code and an ADS-B system such that a Squawk code broadcast by the ADS-B system matches the transponder Squawk code according to an embodiment of the invention;

FIG. 5 is a block diagram of an ADS-B system according to another embodiment of the invention;

FIGS. 6a through 6d are alternative paths through a flowchart of a method of automatically harmonizing a transponder Squawk code and an ADS-B system such that a Squawk code broadcast by the ADS-B system matches the transponder Squawk code according to another embodiment of the invention;

FIG. 7 is an electrical schematic diagram of an ADS-B system according to yet another embodiment of the invention; and

FIG. 8 is a signal diagram of a mode A interrogation signal generated by the ADS-B device and a mode A response signal generated by the transponder.

### DESCRIPTION OF THE EMBODIMENTS

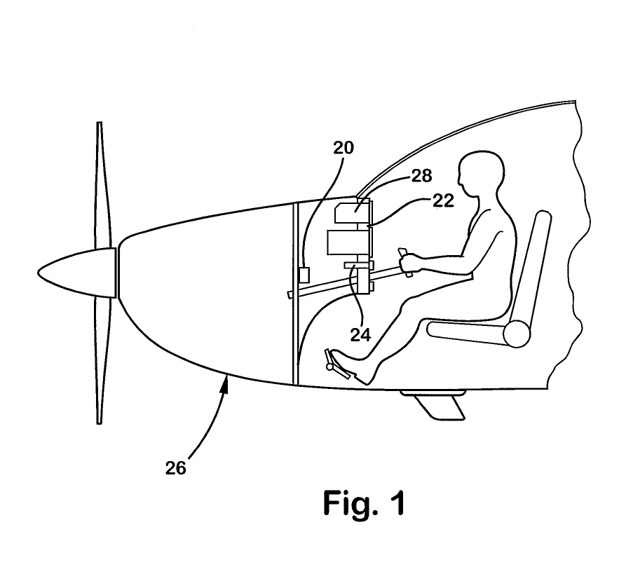

Referring now to the drawings and the illustrative embodiments depicted therein, a transponder decoder 20 according to one embodiment is shown in FIG. 1. As shown therein, transponder decoder 20 is mounted behind an aircraft control panel 22 such that a pilot does not have visual access to the device. FIG. 1 is merely an illustrative example of one location in which transponder decoder 20 may be mounted. In other embodiments, device 20 may be mounted to either be wholly or partially on control panel 22, or it may be mounted in other locations.

Transponder decoder 20 functions to automatically ensure that an ADS-B device 28 onboard the aircraft 26 will not broadcast aircraft information—such as, but not necessarily limited to, a Squawk code—that does not match the aircraft information currently being broadcast by an onboard transponder 24, such as an air traffic control radar beacon system (ATCRBS) for that aircraft. In general, transponder decoder 20 accomplishes this by detecting and decoding the transmissions of transponder 24 and forwarding them to ADS-B device 28 so that ADS-B device 28 may update its Squawk code and other broadcast information—such as pressure altitude and IDENT signals—so that the information wirelessly broadcast by ADS-B device 28 to the air traffic control system and/or other aircraft in the vicinity will match the data currently being broadcast by transponder 24.

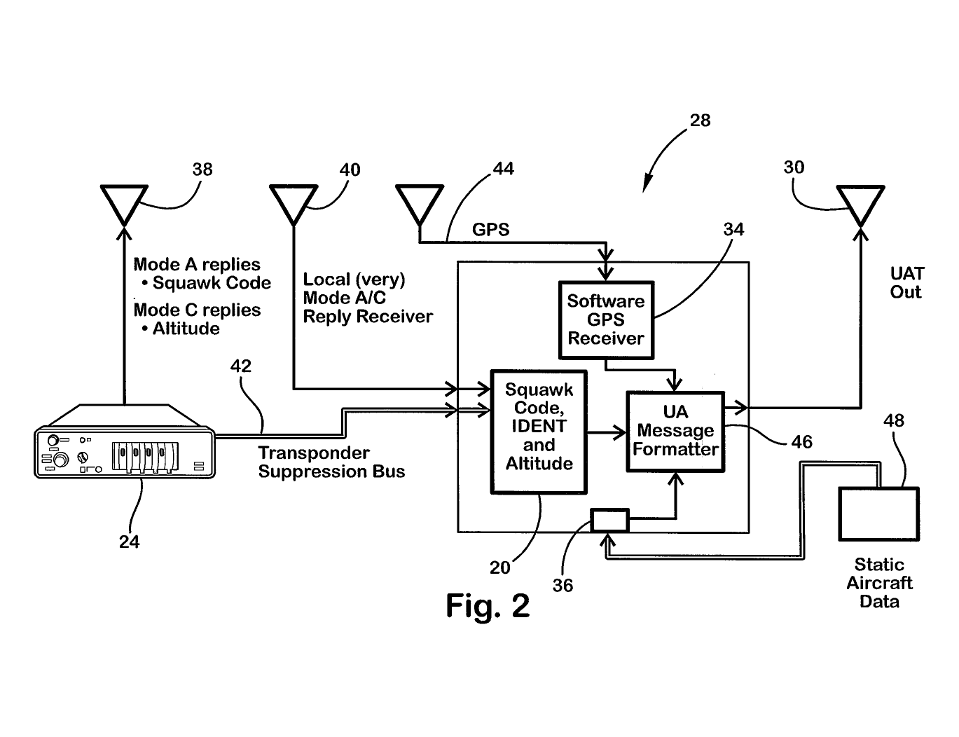

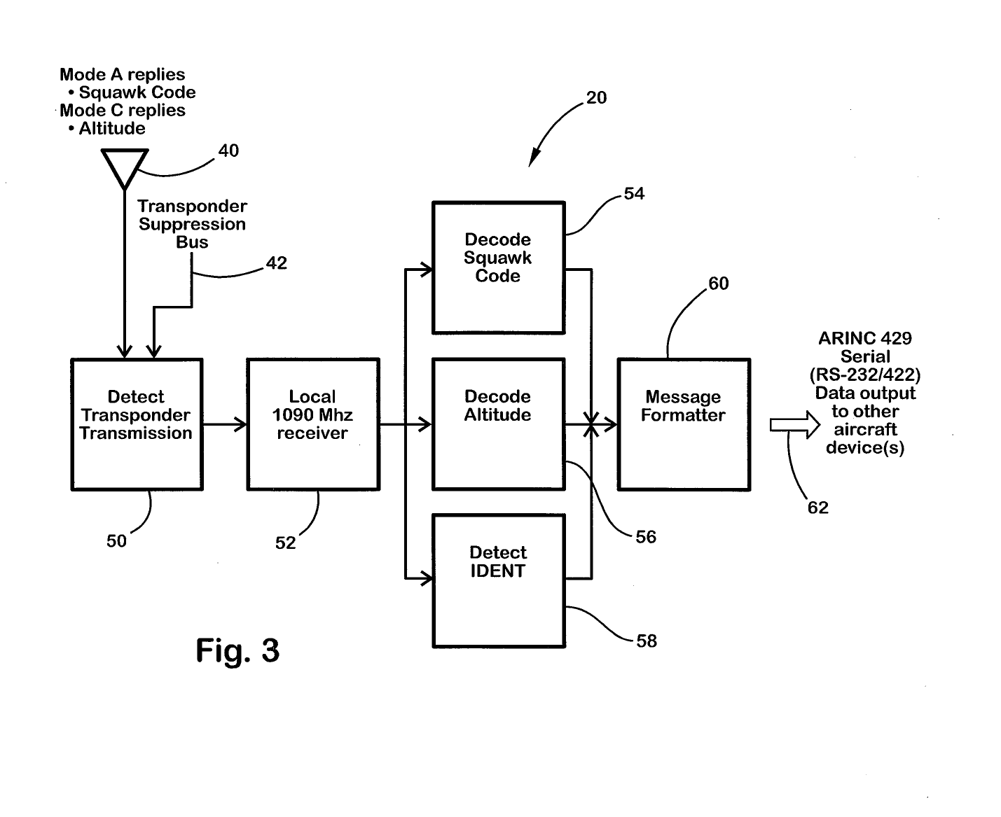

In some embodiments, transponder decoder 20 may be incorporated within ADS-B device 28 itself, rather than being physically separate as shown in FIGS. 1 and 3. For example, in FIG. 2, ADS-B device 28 directly incorporates transponder decoder 20. ADS-B device 28 uses the output of transponder decoder 20 to generate an ADS-B output message that may be broadcast via a Universal Access Transceiver 30. In this embodiment, there need be no physically separate transponder decoder 20 that forwards the detected transponder transmissions to ADS-B device 28, such as in FIGS. 1 and 3. It will be noted that, when ADS-B device 28 incorporates transponder decoder 20, the combined device may be positioned at either the location shown in FIG. 1 for decoder 20, or the location shown for device 28, or in yet another location.

FIG. 2 illustrates greater details of one embodiment of ADS-B device 28. As shown, ADS-B device 28 includes transponder decoder 20, a Global Positioning System (GPS) receiver 34, and a static aircraft receiver 36. Transponder decoder 20 is adapted to receive and process data transmitted by transponder 24, which may be a mode A/C transponder. Transponder 24 works in a conventional manner by responding to interrogations from air traffic control via a ground-based radar system or an airborne collision avoidance (TCAS) system onboard another aircraft, or other interrogations. Such interrogation responses are transmitted wirelessly through an antenna 38 such that the air traffic control system may receive them. Such interrogation responses may include the Squawk code for the aircraft 26, the pressure altitude of aircraft 26 as determined by appropriate onboard equipment, and/or an IDENT signal that may be broadcast through the transponder to air traffic control.

The manner in which transponder decoder 20 receives the information broadcast from transponder 24 can be either via a wireless connection or a wired connection. In the embodiment illustrated in FIG. 2, a wireless connection is shown. That is, transponder decoder 20 is in electrical communication with an antenna 40 that picks up the wireless signals broadcast by transponder 24 through antenna 38. From antenna 40, the detected transponder signals are forwarded to transponder decoder 20 for further processing, as will be discussed more below. In order to ensure that antenna 40 does not detect transponder transmissions from other aircraft that are within the vicinity of aircraft 26, a transponder suppression bus 42 may be in electrical communication with transponder decoder 20 of ADS-B device 28. Such communication may take place through transponder decoder 20, such as is shown in FIG. 2, or it may take place through another communications portal within ADS-B device 28 that then forwards this information onto the necessary components within ADS-B device 28. Transponder suppression bus 42 transmits a signal indicating when transponder 24 is responding to an interrogation. That is, transponder suppression bus 42 transmits a signal when transponder 24 is broadcasting information via antenna 38. ADS-B device 28 may utilize this information in order to distinguish between signals detected by antenna 40 that originated from transponder 24 and signals that may be detected by antenna 40 that originated from transponders aboard other aircraft. In one embodiment, ADS-B-device 28 may use the signals from transponder suppression bus 42 to simply ignore signals detected by antenna 40 except during the times in which antenna 38 is active.

Transponder decoder 20 of ADS-B device 28 may further include other structures or algorithms for distinguishing between transmissions from onboard transponder 24 and transmissions from transponders aboard other aircraft. Such other structures or algorithms may be used either in lieu of, or in addition to, suppression bus 42. As one example; transponder decoder 20 may distinguish between onboard transponder transmissions and transponder transmissions from other aircraft by analyzing the strength of the signals detected on antenna 40. Because antenna 40 will be physically located on the same aircraft 26 as antenna 38, and may be within only a few feet or less of antenna 38, the strength of the signals broadcast by antenna 38 and detected by antenna 40 will be significantly stronger than the strength of the signals that antenna 40 might detect from other aircraft within the vicinity. Other means for distinguishing onboard transponder signals from off-board transponder signals may also be used. And, as noted above, in some embodiments, transponder 24 may communicate with transponder decoder 20 via a wired communication (not shown), in which case there is no need to distinguish transponder 24's transmissions from any other transponders within the area because transponder 24 will be the only transponder in wired communication with transponder decoder 20.

GPS receiver 34 receives GPS information from a GPS antenna system 44. GPS receiver 34 may either compute aircraft position and track information directly from the data received via antenna system 44, or an intermediate device (not shown) positioned between GPS antenna system 44 and receiver 34 may compute the aircraft's position and track information and then forward it to receiver. In either situation, GPS receiver 34 is able to send aircraft position, track, velocity, altitude, and/or any other GPS derived information to a message formatter 46. Message formatter 46 may comprise one or more electronic circuits, processors, systems-on-chip, field-programmable gate arrays (FPGA), or other electronic components—as would be known to one of ordinary skill in the art—that are capable of building messages in accordance with the ADS-B protocol. In the illustrated embodiment, such messages are transmitted wirelessly off the aircraft 26 through a UAT device 30. In other embodiments, a different transceiver may be used for transmitting the ADS-B data, such as a 1090 megahertz (MHz) transceiver, or other type. As is known to those skilled in the art, the ADS-B messages include, at a minimum, the aircraft's Squawk code and data identifying the aircraft's state vector (3-dimensional position and 3-dimensional velocity).

Static aircraft receiver 36 receives static information about aircraft 26 from a memory 48. While memory 48 is shown physically separate from ADS-B device 28 in FIG. 2, memory 48 may be incorporated into ADS-B device 28 in some embodiments. Memory 48 stores information specific to aircraft 26 that may be included in the transmissions made by ADS-B device 28. Thus, message formatter 46, which receives the static aircraft information via static aircraft receiver 36, is able to incorporate, to the extent necessary, static aircraft information into one or more ADS-B transmissions.

As is also shown in FIG. 2, message formatter 46 receives the transponder detected information from transponder decoder 20. This information includes the currently used Squawk code that is being broadcast by transponder 24. It may also include the pressure altitude information being broadcast by transponder 24 and/or the IDENT signal being broadcast by transponder 24. However, altitude information may be supplied to both transponder 24 and ADS-B device 28 from a common altitude sensor so that transponder 24 and ADS-B device 28 transmit the same aircraft altitude data. Message formatter 46 incorporates the information received from transponder decoder 20, GPS receiver 34, and static aircraft receiver 36 into one or more messages that are in compliance with the ADS-B standards, as promulgated by the U.S. Federal Aviation Administration, and/or another governing body or organization. After such messages are generated, they are broadcast wirelessly so that both the air traffic control system and other aircraft within the vicinity of aircraft are able to receive them. As shown, such broadcasts may take place through universal access transceiver 30, although other communications links may be used.

FIG. 3 illustrates an example of a transponder decoder 20′ according to another embodiment. Transponder decoder 20′ includes several components in common with ADS-B device 28, such as antenna 40 and transponder suppression bus 42. Such common components operate in the same manner as has been described above and include the same reference numbers. Further description of such components therefore need not be provided.

Transponder decoder 20′ includes a transponder detector 50 that receives communications from transponder 24 via antenna 40, or in other embodiments, via a wired connection. Transponder detector 50 may also receive signals from transponder suppression bus 42. Transponder detector 50 forwards the detected transponder transmissions to a 1090 MHz receiver 52, which process the 1090 MHz transmissions of transponder 24. As is known to one of ordinary skill in the art, the 1090 MHz transmissions of transponder 24 may include a Squawk code, a pressure altitude, or an IDENT signal. The manner in which these three different pieces of data are encoded by transponder 24 is different. In order to determine which data is being broadcast by transponder 24, a squawk code decoder 54, a pressure altitude decoder 56, and an IDENT decoder 58 are included within transponder decoder 20′. Decoders 54, 56, and 58 determine which type of data is being transmitted by transponder 24 and pass the decoded data onto message formatter 60. Message formatter 60 receives the decoded squawk code, the pressure altitude, and the IDENT signal—if present—and forwards it onto a communications channel 62, which may be an ARINC 429 channel, or some other type of communication channel. One or more other avionics devices onboard the aircraft that are also in communication with channel 62 may utilize this data to automatically update the ADS-B transmissions so that the squawk code, pressure altitude, and IDENT signal—if present—for both the transponder and the ADS-B system match.

From the examples illustrated in FIGS. 2 and 3, and the corresponding description provided herein, it can be seen that the various embodiments provide alternative methods for automatically ensuring that an aircraft's transponder and ADS-B system remain in agreement about common data, such as a squawk code and pressure altitude that they broadcast. In the example of FIG. 2, the ADS-B device 28 communicates directly with the transponder 24 and broadcasts ADS-B messages. In the example of FIG. 3, the transponder decoder 20′ detects the transponder 24 communications, decodes them, and then distributes them to a communications channel where other avionics devices can utilize them and update themselves with the latest transponder data. In either embodiment, when a pilot manually changes the squawk code on the transponder 24, the ADS-B system will automatically update itself with this changed data after the transponder 24 makes its first broadcast of the data. This substantially avoids the problem of a single aircraft broadcasting different or multiple squawk codes. It also avoids burdening the pilot with having to manually enter the changed squawk code into two different instruments.

The various components of the transponder decoder 20, 20′ and ADS-B device 28 may be constructed from known electronic circuitry, as would be known to one of ordinary skill in the art. Such circuitry may include one or more electronic processors, integrated circuits, memory chips, field programmable gate arrays, systems-on-chip, and/or any other electronic components useful or necessary for carrying out the algorithms and processes described herein. It will also be understood by those skilled in the art that various modifications can be made to the illustrative embodiments described above. As but one example, the internal components of ADS-B device 28 may be changed from that shown in the drawings. For example, ADS-B device 28 of FIG. 2 includes two separate receivers: GPS receiver 34 and static aircraft receiver 36. These receivers could be combined such that a single receiver received both inputs. Indeed, ADS-B device 28 could have a single communications channel input that received all of the transponder information, GPS information, and static aircraft information via the same input. Alternatively, multiple communications channels could feed this information to ADS-B device 28. Still other variations are possible.

A potential conflict in operation of a transponder decoder 20, 20′ as previously described is that the format of the reply message from transponder 24 is the same for both a mode A and a mode C response. The ground radar or TCAS collision avoidance system of another aircraft is able to correlate the reply message from the transponder with the interrogation message it transmitted and is thus able to interpret the data encoded in the reply message from the transponder as being either an altitude (Mode C) response or a Squawk code (mode A) response. Transponder decoder 20, 20′ does not have knowledge of the interrogation message transmitted by the ground radar or from TCAS of another aircraft. Transponder decoder 20, 20′ may be provided with a control technique 65 for ensuring that decoder 20, 20′ only transmits as a squawk code message to the air traffic control system or other aircraft in vicinity a mode A Squawk code message from transponder 24. This ensures that the transponder decoder does not inadvertently treat a Mode C message from transponder 24 as a mode A Squawk code thereby causing transponder 20′ to transmit a Squawk code message that matches a current pressure altitude of the aircraft rather than the Squawk code transmitted by transponder 24.

Control technique 65 is based upon the requirement that the UAT device must output the same mode A code as transponder 24 and both the UAT device and transponder 24 must output aircraft altitude from the same altitude source. Therefore, control technique 65 compares the transponder transmission to the aircraft's current altitude. If the transponder transmission does not correlate with the aircraft altitude, then control technique 65 concludes that the transmission from transponder 24 is a mode A Squawk transmission. If the transmission from transponder 24 and the aircraft's current altitude result in the same bits being set in the reply message, then corrective action is taken to resolve the ambiguity.

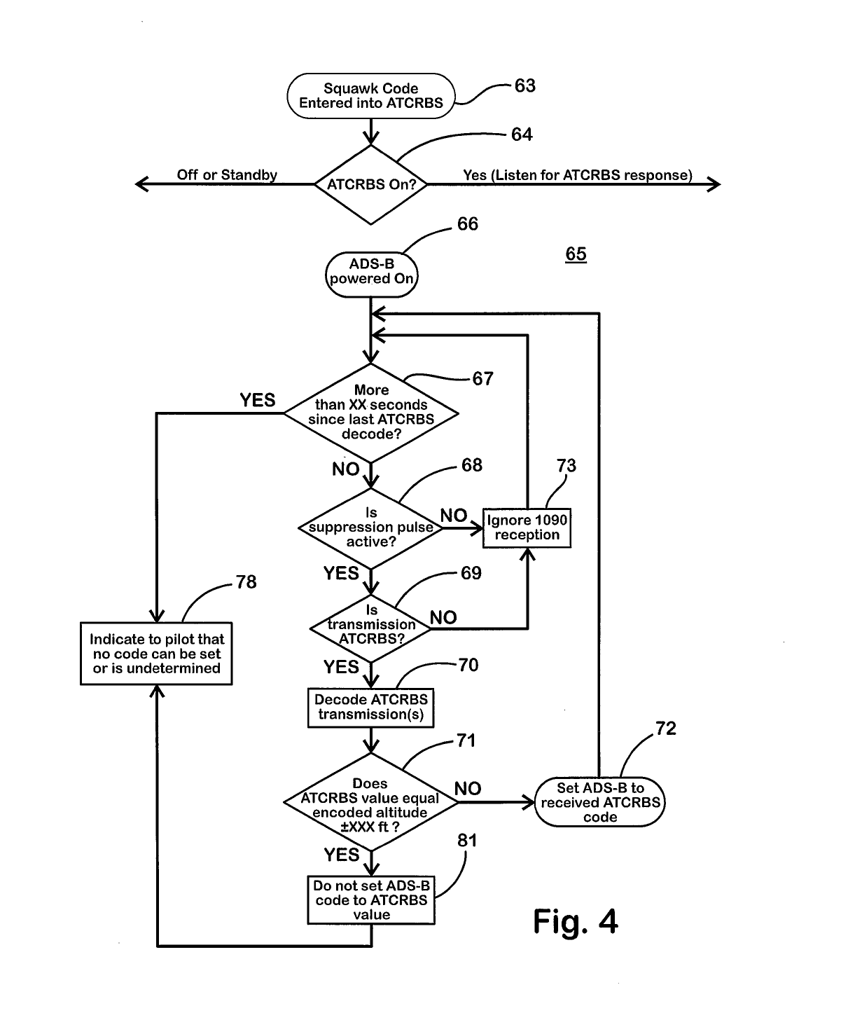

In an embodiment illustrated in FIG. 4, the corrective action taken by control technique 65 for the code value transmitted by transponder 24 equaling the aircraft altitude would be to notify the pilot that the UAT device is not able to unambiguously determine the Squawk code. The pilot could then, for example, press the IDENT button on transponder 24. The IDENT button on transponder 24 adds an identifiable pulse at the end of all mode A reply messages, such as a pulse of a particular period, such as 18 seconds, which would allow the UAT device to unambiguously determine which reply message contains the squawk code. Referring now to FIG. 4, control technique 65 begins at 63 with the pilot entering the squawk code in transponder 24. When this occurs, the transponder is either off or in the standby mode or is on (64). If it is on, transponder 20, 20′ receives transmissions from transponder 24.

Control technique 65 then begins at 66 with transponder decoder 20, 20′ being powered on and determining at 67 whether more than a predetermined amount of time has passed. This would occur if either (i) transponder 24 is off or standby, (ii) transponder 24 is not operational or (iii) the aircraft is in an area where it is not receiving inquiries from ground radar or TCAS transmissions from other aircrafts. If it is determined at 67 that the predetermined amount of time has passed, then an indication is given at 78 to the pilot of the status. The pilot would then take action, such as to turn transponder 24 on or place it in active mode, if off or in standby mode, or to press the IDENT button on transponder 24 which would allow the UAT device to receive an identifiable mode A Squawk transmission from transponder 24.

If it determined at 67 that less than the predetermined amount of time has passed, control technique 65 looks at the status of transponder suppression line 42 to determine whether a device onboard the aircraft is transmitting. If not, then any transmission received by transponder decoder 20, 20′ at the frequency of transponder 24 is not originating from the transponder onboard that aircraft and is thereby ignored at 73. If suppression line 42 indicates that a device onboard the aircraft is transmitting, then it is determined at 69 whether the transmission is of the type that would originate from transponder 24. If not, it is ignored at 73. If it is determined at 69 that the transmission is from transponder 24, then it is decoded at 70 and is compared at 71 with the pressure altitude information for the aircraft. If the value of the transmission from transponder 24 does not correlate with the pressure altitude information of the aircraft, then it is concluded that the transmission from transponder 24 is a mode A Squawk code and ADS-B device 28 utilizes the code transmitted by transponder 24 to encode its squawk code.

If it is determined at 71 that the transmission from transponder 24 equals the altitude information from the aircraft, then ADS-B device 28 is not able to unambiguously determine the Squawk code. The ADS-B device does not set its Squawk code to the value transmitted from the transponder transmission and corrective action is taken, such as an indication is provided to the pilot at 78. The pilot can take action, such as pressing the IDENT button on transponder 24, to cause the transponder to transmit an identifiable Squawk code.

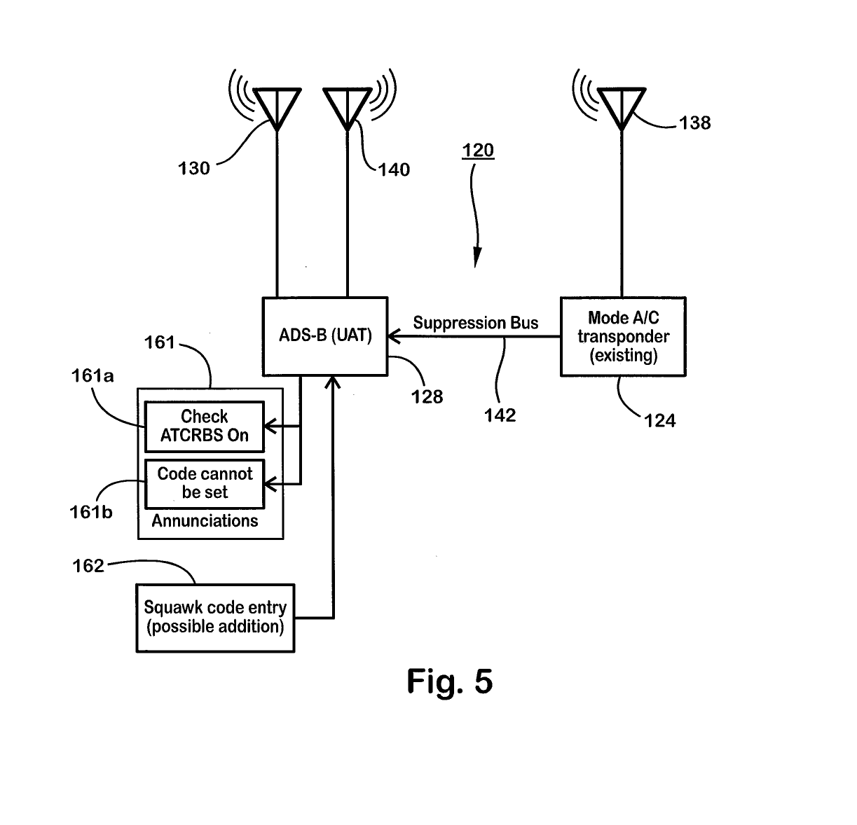

In an alternative embodiment, an Automatic Dependent Surveillance-Broadcast (ADS-B) system 120 for an aircraft is useful with a mode A/mode C transponder 124 having a transponder antenna 138 (FIG. 5). System 120 includes an ADS-B 128 device having a UAT transmitter 140 and a low power transceiver antenna 140 that can output a mode A interrogation message directly to transponder 124 wherever the transmission from transponder 124 equals the altitude information from the aircraft or ADS-B system 120 is otherwise unable to unambiguously determine the Squawk code. Since transceiver antenna 140 sends a mode. A interrogation message, it can conclude that the transmission from transponder 124 is a mode A Squawk code. Transceiver antenna 140 can be separate from the UAT transceiver 130 used to transmit to the ground or to other aircraft or can be a combined transceiver that is capable of wireless communication with transponder antenna 138. If a common transceiver antenna is used, then it would transmit at a lower power level to interrogate transponder 124 than would be used as a UAT transceiver mode.

System 120 includes a suppression bus 142 that is used to indicate that an L-band system onboard the aircraft is transmitting. It is used by ADS-B device 128 as a trigger to receive transmissions from transponder 124. System 120 may further include pilot annunciators 161, such as an indicator 161a, to advise the pilot to check that transponder 124 is on and in an active mode. Also, an indicator 161b may be included to inform the pilot that a Squawk code cannot unambiguously be determined so that the pilot can press the IDENT button on transponder 124. System 120 may further include an optional Squawk code entry device 162 that may allow the pilot to manually enter a Squawk code to ADS-B device 128 should transponder 124 malfunction so that it is not possible for ADS-B device 128 to receive a code from transponder 124.

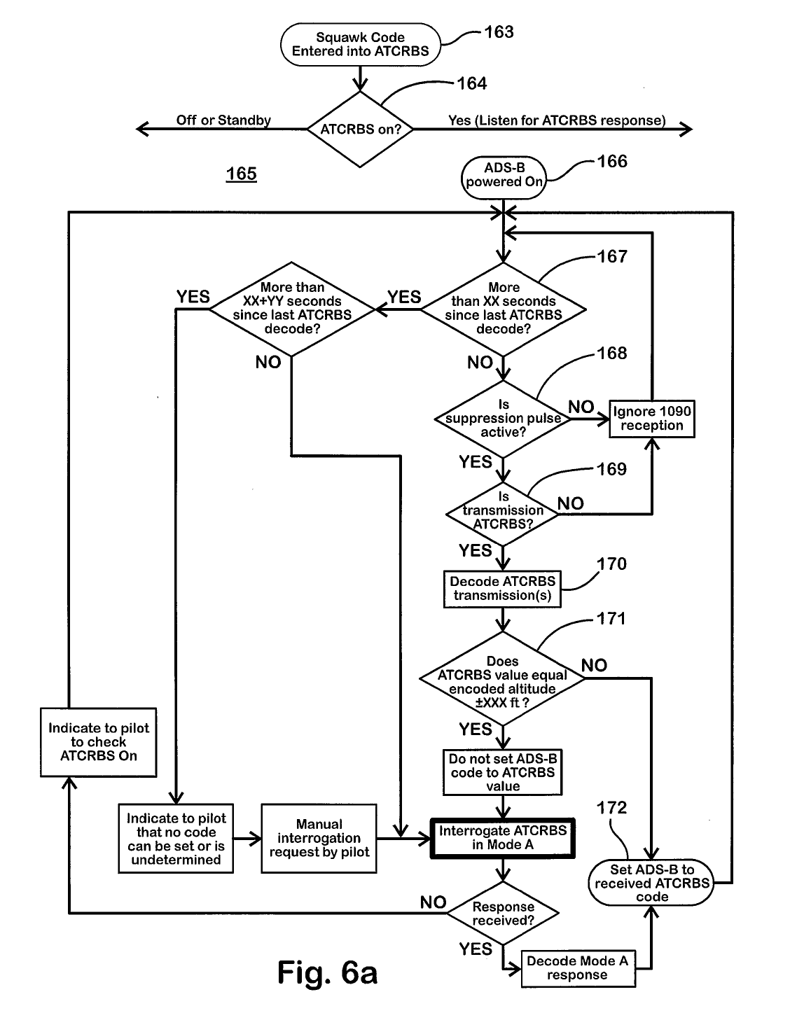

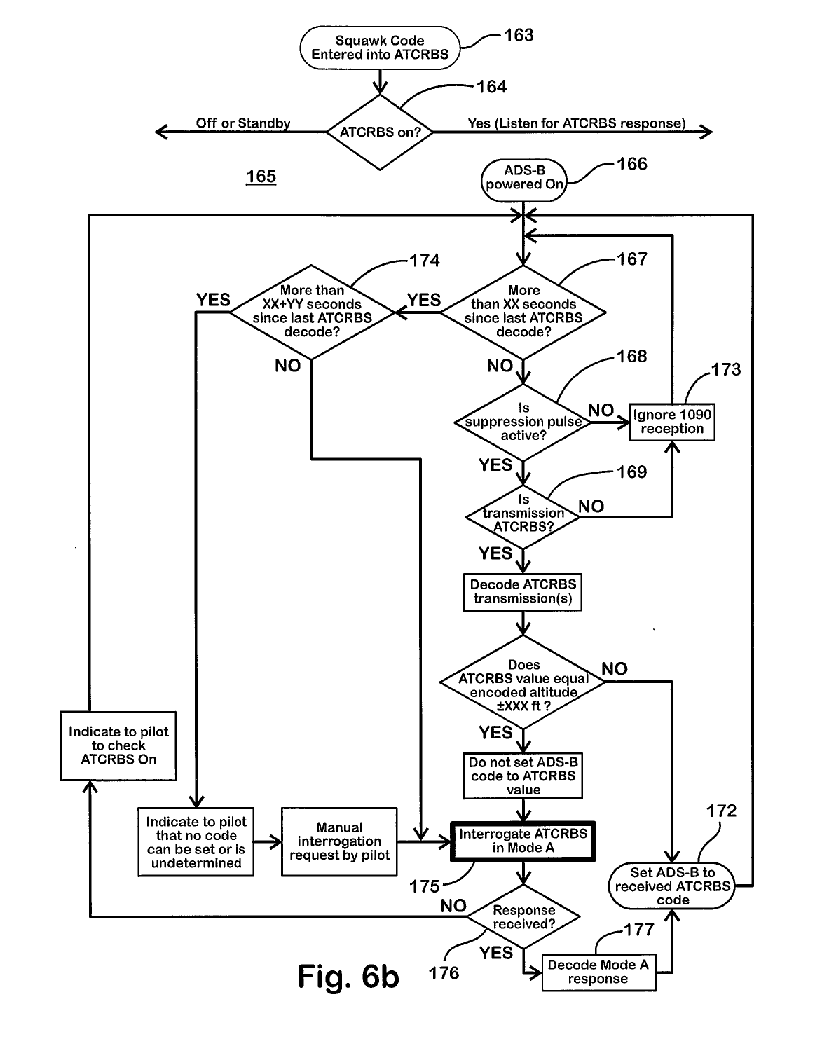

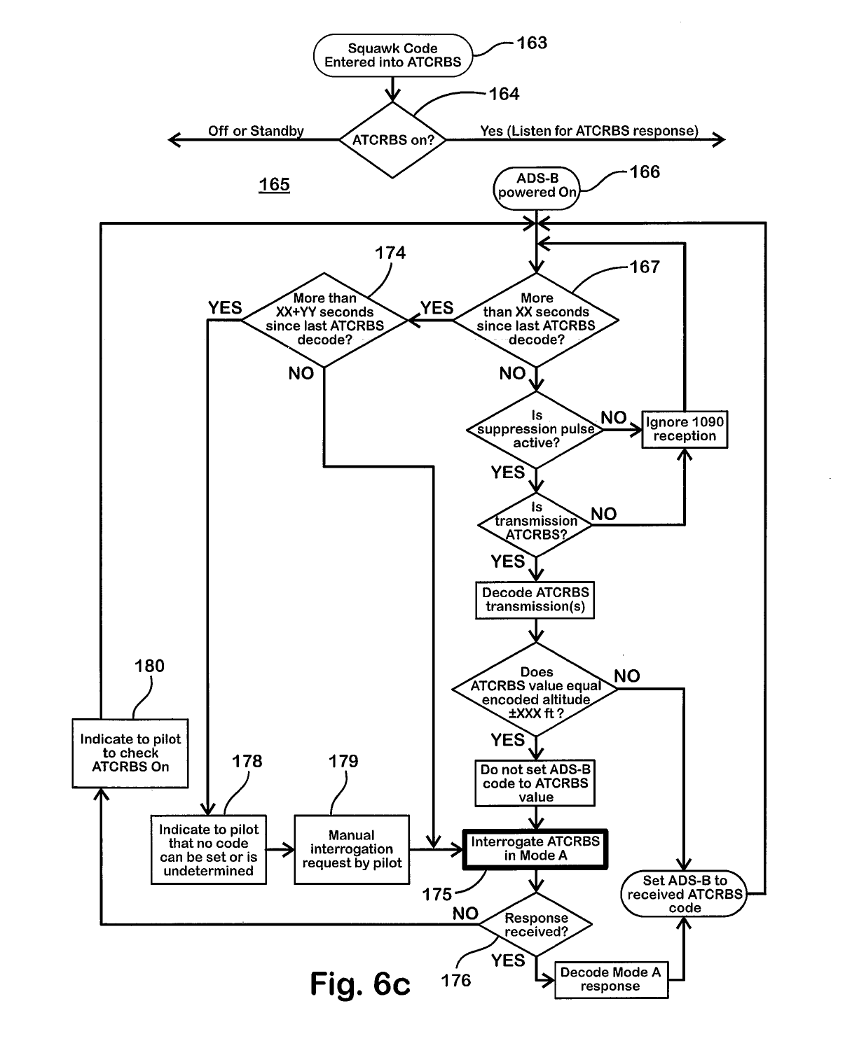

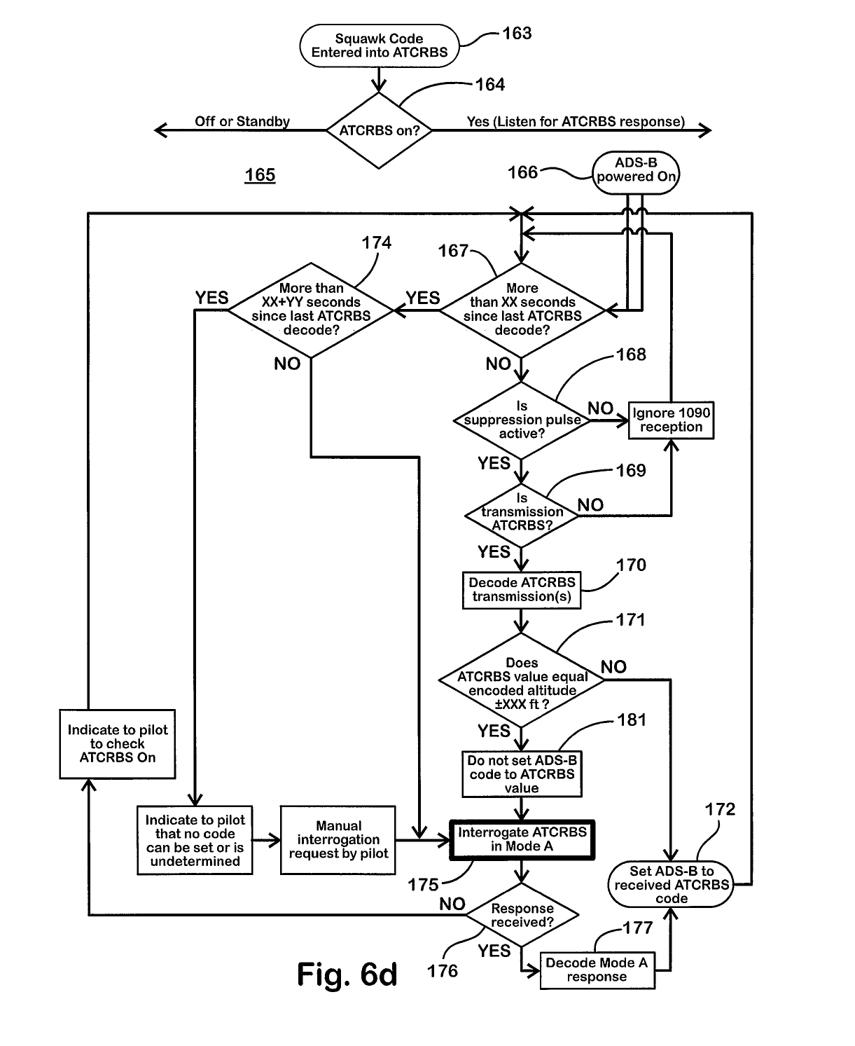

System 120 includes a control technique 165 for ensuring that ADS-B device only transmits as a squawk code message to the air traffic control system or other aircraft in the vicinity of a mode A Squawk code message from transponder 124. Operation of control technique 165 can be understood by reference to FIGS. 6a-6d. FIGS. 6a-6d illustrate different flow paths through control technique 165 for different operating conditions of transponder 124.

Normal operation of ABS-B, in which it is able to unambiguously receive a mode A Squawk code message for transponder 124 is illustrated in FIG. 6a. With the pilot entering a Squawk code message (163) in transponder 124 and transponder 124 operational (164), the ADS-B device is also powered on at 166. It is determined at 167 whether more than a predetermined amount of time has passed since the last transmission has been received since the last transmission from transponder 124. Since transponder 124 is operational and has recently transmitted a message in response to a ground radar or from a TCAS unit onboard another aircraft, it is determined at 167 that this predetermined time has not passed and it is then determined at 168 whether suppression line 142 is active, which will occur at least when transponder 124 is transmitting. If so, the message received by transceiver 140 is examined at 169 to determine if it has the format of a message from transponder 124. If so, the message is decoded at 170. Once the message is decoded, it is compared at 171 with the altitude information obtained by ADS-B device 128, such as from an altimeter that supplies altitude data to both transponder 124 and ADS-B device 128.

If the message decoded from transponder 124 is determined at 171 to not be the same as the altitude information, it is determined that the message must be a mode A Squawk code message so it is adopted at 172 by ADS-B device 128 as the Squawk code to be used by ADS-B device 128 for future transmissions until changed by the pilot by entering a different Squawk code in transponder 124.

FIG. 6b illustrates operation of control technique 165 when transponder 124 is not being interrogated by a ground radar or a TCAS unit in another aircraft. When the pilot enters a Squawk code into transponder 124 at 163, the transponder is operational at 164. With ADS-B unit 128 turned on at 166, it is determined at 167 if more than a predetermined period of time, such as several seconds, has passed since last receipt of a transmission from transponder 124. If this period has not yet passed, it is determined at 168 whether suppression line 142 is active. If so, it is determined at 169 whether the device that is transmitting is transmitting a message having a protocol of a message transmitted by transponder 124. If not, the message is ignored at 173. This sequence is repeated until it is determined at 167 that more than the predetermined amount of time has passed. It is then determined at 174 whether a longer predetermined period of time, such as tens of seconds, has lapsed.

If it is determined at 174 that a longer predetermined period of time has not lapsed, ADS-B device 128 interrogates transponder 124 by sending an attenuated signal at 175 to transponder 124 having a format of a mode A code interrogation. This is accomplished either by sending the interrogation signal with an antenna 140 dedicated to communication with transponder 124 or by a UAT antenna 130 that is used both to communicate with transponder 124, at an attenuated signal level, and to generate ADS-B UAT signals external to the aircraft. It is then determined at 176 whether a response is received. If so, then it is concluded at 177 that it is a mode A Squawk message and it is used to set the Squawk code for ADS-B device at 172. In this manner, it is possible to set the Squawk code for ADS-B device even if the transponder is not being interrogated by a ground radar or a TCAS unit of another aircraft.

The situation of transponder 124 being turned off or has failed is illustrated with respect to FIG. 6c. If it is determined at 167 and 174 that a response is not received within the extended predetermined period of time after interrogation of transponder 124, then it is concluded that the transponder must be turned off or failed. A message is then given to the pilot at 178, such as with annunciator 161a instructing the pilot to turn the transponder to an active mode.

If it is determined at 176 that a message has not been received from transponder 124 even after having attempted to interrogate the transponder at 175, it is then concluded that the transponder is likely malfunctioning. An indication is given to the pilot at 180, such as using annunciator 161b that the code cannot be set using control technique 165. The pilot may be instructed to manually enter a squawk code in ADS-B device, such as with an optional squawk code entry device 162 or may be optionally instructed to attempt to manually interrogate transponder 124. In this manner, it may be possible to enter a Squawk code in ADS-B device even if transponder 124 is powered off or has failed.

The situation of transponder 124 being set to a Squawk code that is indistinguishable from the altitude data received by ADS-B device 128 is illustrated with respect to FIG. 6d. With a Squawk code entered into transponder 124 at 163, the transponder is powered on (164). With ADS-B device powered at 166, it is determined at 167 that the lower predetermined period of time has not passed since last transmission of transponder 124 since the transponder is being interrogated by a ground radar or a TCAS unit on another aircraft. If it is determined at 168 that suppression bus 142 is active and at 169 that the transmission is from transponder 124, the transmission is decoded at 170 and compared at 171 with the altitude data received by ADS-B device 128. Since it will, under this scenario, be determined that the transmission from transponder 124 is indistinguishable from the altitude value, the transmission from transponder 124 is not used to set the Squawk code in ADS-B device 128 at 181. Instead, transponder 124 is interrogated at 175 with UAT transceiver 140 at an attenuated signal level, or by separate transceiver 130. A response should be received at 176 since the transponder is turned on and is not failed. Because the response is from a mode A interrogation signal, it is decoded at 177 and adopted by ADS-B device 128 as the Squawk code of transponder 124 at 172.

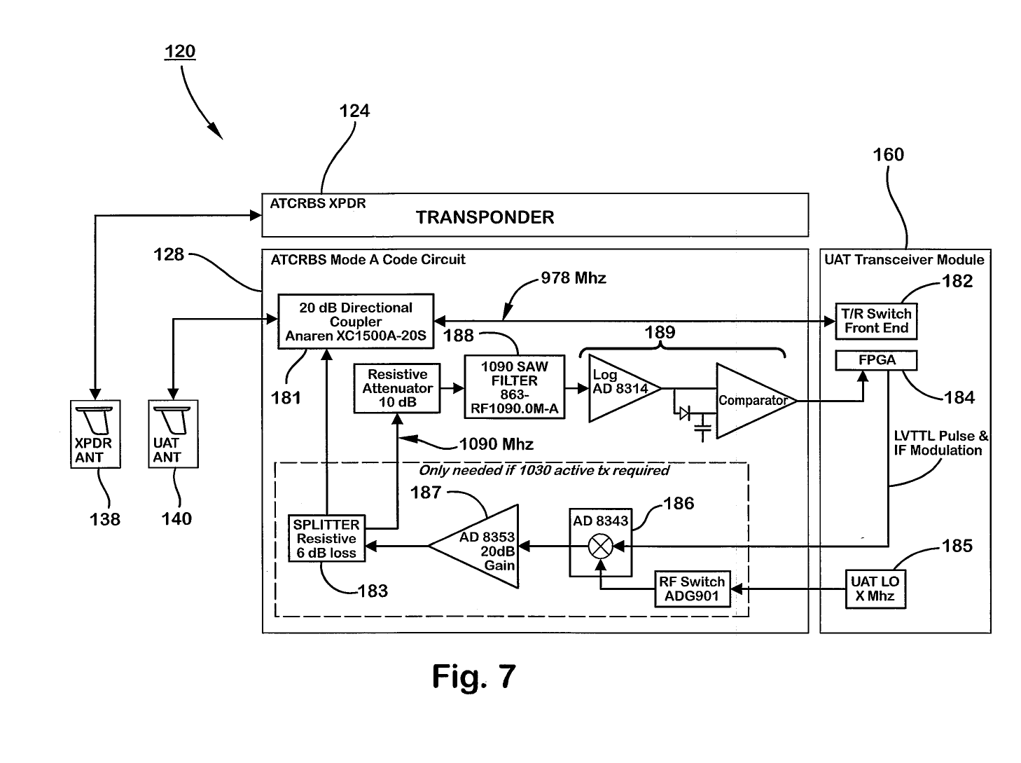

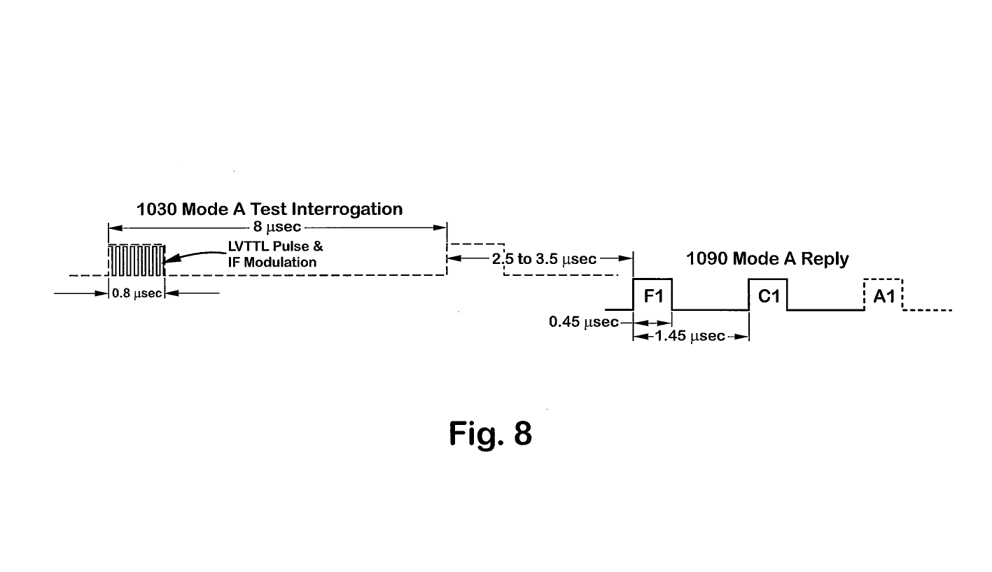

A detailed schematic of ADS-B system 120 is illustrated in FIG. 7. ADS-B device 128 includes a directional coupler 181 that provides a low-loss path to the transceiver 182 of UAT transceiver module 160. Such transmissions take place at 978 MHz via UAT antenna 140. Directional coupler 181 provides an attenuated path, which is attenuated at 20 dB in the illustrated embodiment, to a splitter 183. Splitter 183 applies a signal to directional coupler 181 that is generated by a field programmable gate array 184 or other logic device, such as a microprocessor, which formats messages for normal transmission by ADS-B device. Gate array 184 produces digital pulses at 30 MHz, which results in 0.8 microsecond pulses as seen in FIG. 8. The pulse output from gate array 184 is mixed with a 1.0 GHz signal from a local oscillator 185 via a mixer 186 to produce 970 MHz and 1030 MHz modulated pulses. An amplifier 187 amplifies the 970 MHz modulated pulses and 1030 MHz pulses, which are transmitted with the UAT antenna 140 as a mode A interrogation signal. The transponder receiver filter will reject the 970 MHz pulses and process the 1030 MHz pulses as a valid mode A interrogation signal.

The mode A interrogation signal is received by transponder antenna 138 which causes transponder 124 to generate a mode A response which is a series of digital pulses modulated with a 1090 MHz carrier as seen in FIG. 8. This mode A response is received wirelessly by antenna 140 and fed through the attenuated path of directional coupler 181 through splitter 183 to a filter 188. Filter 188 passes only the signal received at 1090 MHz which is the mode A signal generated by transponder 124. A detector 189 eliminates the carrier to produce a digital pulse stream seen in FIG. 9 which is supplied to gate array 184 as the Squawk code to which transponder 124 is set. Gate array 184 is a message formatter that formats the ADS-B message transmitted by transceiver module 160. In this manner UAT message formatter 160 formats ADS-B signals that contain a Squawk code that is set to the same value as the squawk code of transponder 124 whether the Squawk code is a result of passively interpreting the transmission of transponder 124 that is being interrogated by a ground radar/TCAS system or is a result of active interrogation by ADS-B device 128.

While illustrated for use in ensuring that a common mode A Squawk code is used in the ADS-B device as in the transponder, the same technique could be used for mode C code signals or other types of code.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

What is claimed is:

1. A transponder decoder for an aircraft comprising:
an input adapted to receive a mode A/C transponder transmission from a transponder positioned aboard the aircraft;
a decoder adapted to decode the mode A/C transponder transmission; and
an output for outputting the decoded mode A/C transponder transmission.

2. The transponder decoder of claim 1 further including an Automatic Dependent Surveillance-Broadcast (ADS-B) device coupled to said output, said ADS-B device adapted to wirelessly broadcast at least the decoded mode A/C transponder transmission data.

3. The transponder decoder of claim 2 wherein said input comprises an antenna adapted to wirelessly detect the mode A/C transponder transmission.

4. The transponder decoder of claim 2 wherein said ADS-B device wirelessly broadcasts the decoded mode A/C transponder transmission using a Universal Access Transceiver (UAT).

5. The transponder decoder of claim 2 wherein said transponder transmission includes at least one chosen from a Squawk code and a pressure altitude.

6. The transponder decoder of claim 5 wherein said ADS-B device is adapted to determine that a transponder transmission is a Squawk code.

7. The transponder decoder of claim 6 wherein said ADS-B device is adapted to determine that a transponder transmission is a Squawk code by determining that the transponder transmission does not have the same value as pressure altitude information for the aircraft.

8. The transponder decoder of claim 6 wherein said ADS-B device is adapted to take an alternative action if it cannot determine that the transponder transmission is a Squawk code.

9. The transponder decoder of claim 8 wherein the alternative action comprises providing an indication to the pilot.

10. The transponder decoder of claim 8 wherein the alternative action comprises sending an interrogation signal to activate said transponder to send a Squawk code.

11. The transponder decoder of claim 10 wherein said antenna sends the interrogation signal to said transponder.

12. The transponder decoder of claim 1 that is adapted to send an interrogation signal to activate said transponder to send a Squawk code.

13. The transponder decoder of claim 12 wherein said antenna sends the interrogation signal to said transponder.

14. The transponder decoder of claim 6 wherein said ADS-B device is adapted to determine that the transponder is not transmitting.

15. The transponder decoder of claim 14 wherein said ADS-B device is adapted to distinguish between said transponder not transmitting because (i) the transponder is not operational or (ii) the transponder is not being interrogated.

16. An Automatic Dependent Surveillance-Broadcast (ADS-B) system for an aircraft comprising:
a transponder decoder comprising an input adapted to receive a mode A/C transponder transmission from a transponder positioned aboard the aircraft, a decoder adapted to decode the mode A/C transponder transmission and an output for outputting the decoded mode A/C transponder transmission;
a message formatter adapted to generate a message based on data received from said transponder decoder output, the message including data identifying the squawk code; and
a wireless transmitter in communication with said message formatter, said wireless transmitter adapted to wirelessly broadcast said message.

17. The ADS-B system of claim 16 wherein said transponder decoder receives said squawk code wirelessly from the transponder.

18. The ADS-B system of claim 16 wherein said transponder decoder also receives altitude information broadcast from said transponder and forwards said altitude information to said message formatter for formatting into the message.

19. The ADS-B system of claim 16 wherein said message formatter is adapted to determine that a transponder transmission is a Squawk code.

20. The ADS-B system of claim 19 wherein said message formatter is adapted to determine that a transponder transmission is a Squawk code by determining that the transponder transmission has a value that is not the same value as altitude information for the aircraft.

21. The ADS-B system of claim 19 wherein said message formatter is adapted to take an alternative action if it cannot determine that the transponder transmission is a Squawk code.

22. The ADS-B system of claim 21 wherein the alternative action comprises providing an indication to the pilot.

23. The ADS-B system of claim 21 wherein the alternative action comprises sending an interrogation signal to activate said transponder to send a Squawk code.

24. The ADS-B system of claim 23 wherein said wireless transmitter sends the interrogation signal to said transponder.

25. The ADS-B system of claim 16 that is adapted to send an interrogation signal to activate said transponder to send a Squawk code.

26. The ADS-B system of claim 25 wherein said wireless transmitter sends the interrogation signal to said transponder.

27. The ADS-B system of claim 19 wherein said message formatter is adapted to determine that the transponder is not transmitting.

28. The ADS-B system of claim 27 wherein said message formatter is adapted to distinguish between said transponder not transmitting because (i) the transponder is not operational or (ii) the transponder is not being interrogated.

29. The ADS-B system of claim 16 further including a transponder suppression bus input adapted to be coupled to a transponder suppression bus, said transponder suppression bus input adapted to receive a signal to help differentiate between data transmitted by said transponder onboard the aircraft and data transmitted by any transponders off-board said aircraft.

30. The ADS-B system of claim 16 wherein said transponder decoder also receives IDENT information broadcast from said transponder and forwards the IDENT information to said message formatter for formatting into said message.

31. The ADS-B system of claim 16 wherein said wireless transmitter is a component of a Universal Access Transceiver (UAT).

32. A method of automatically harmonizing a transponder squawk code and an ADS-B system such that a squawk code broadcast by the ADS-B system matches the transponder squawk code, said method comprising:
transmitting said transponder squawk code from a transponder positioned onboard an aircraft;
receiving the transmitted transponder squawk code with a device positioned onboard the aircraft;
updating the ADS-B system with the received transmitter squawk code; and
broadcasting the squawk code using the ADS-B system.

33. The method of claim 32 wherein receiving the transmitted transponder squawk code is performed wirelessly using an antenna.

34. The method of claim 32 further including receiving a signal from a transponder suppression bus and using said signal to help differentiate between data transmitted by said transponder onboard the aircraft and data transmitted by any transponders off-board said aircraft.

35. The method of claim 32 further including receiving altitude information broadcast from said transponder and forwarding said altitude information to a message formatter for formatting into said message.

36. The method of claim 32 including determining that a transponder transmission is a mode A Squawk code.

37. The method of claim 36 wherein said determining that a transponder transmission is a Squawk code includes determining that the transponder transmission has a value that is not the same value as altitude information for the aircraft.

38. The method of claim 36 including taking alternative action if it cannot be determined that the transponder transmission is a Squawk code.

39. The method of claim 38 wherein the alternative action comprises providing an indication to the pilot.

40. The method of claim 38 wherein the alternative action comprises sending an interrogation signal to activate said transponder to send a Squawk code.

41. The method of claim 40 including sending the interrogation signal to said transponder with the ADS-B system.

42. The method of claim 32 including sending an interrogation signal to activate said transponder to send a Squawk code.

43. The method of claim 42 including sending the interrogation signal to said transponder with the ADS-B system.

44. The method of claim 36 including determining that the transponder is not transmitting.

45. The method of claim 44 wherein said determining that the transponder is not transmitting includes distinguishing between said transponder not transmitting because (i) the transponder is not operational or (ii) the transponder is not being interrogated.
